(19) United States
(12) Patent Application Publication
(10) Pub. No.: US 2004/0166200 A1
(43) Pub. Date: Aug. 26, 2004

(54) Seasoning and the process of producing it

(75) Inventors: Daiki Ninomiya, Kawasaki-shi (JP); Kyoko Koibuchi, Kawasaki-shi (JP); Sachi Hirai, Kawasaki-shi (JP); Hideki Okamura, Kawasaki-shi (JP); Naoko Tanaka, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Ajinomoto Co., Inc., Tokyo (JP)

(21) Appl. No.: 10/729,935

(22) Filed: Dec. 9, 2003

(30) Foreign Application Priority Data
Dec. 10, 2002 (JP) 2002-358575

(51) Int. Cl. A23K 1/00

(52) U.S. Cl. 426/52

(57) ABSTRACT

The present invention relates to an amino acid composition. More specifically, the present invention provides an amino acid composition obtained by hydrolyzing proteinaceous koji containing soybean protein as the main raw material to release at least 65% of amino acids contained in the protein. The present invention further provides a process of producing the amino acid composition.

### CROSS REFERENCE TO RELATED CASES

The present application claims priority to Japanese Application No. 358575/2002, filed on Dec. 10, 2002, which is hereby incorporated by reference in its entirety.

### BACKGROUND OF THE INVENTION

1. Field of the Invention

The present invention relates to an amino acid composition. More specifically, the present invention provides an amino acid composition obtained by hydrolyzing proteinaceous koji containing soybean protein as the main raw material to release at least 65% of amino acids contained in the protein. The present invention further provides a process of producing the amino acid composition.

2. Discussion of the Background

Seasoning materials containing amino acids such as glutamic acid and peptides have been used so far to give umami and body to processed food products and various seasonings such as noodle soups, dips and seasoning liquids for pickles. Among these materials, proteins of vegetables such as soybean and proteins of animals such as cow, pork and chicken have been used commonly after being processed by acidic or enzymatic hydrolysis. Particularly, hydrolyzed vegetable proteins (HVP) obtained by acid hydrolysis of vegetable proteins, as well as soy sauce as one of traditional Japanese fermentation seasonings, are representative.

Because HVP is currently produced by hydrolysis of protein-abundant cereals and beans (e.g., soybean) with hydrochloric acid at high temperature, almost 100% of the proteins therein are hydrolyzed to amino acids. Therefore, the resulting hydrolyzed product contains a vast amount of amino acids, such as glutamic acid, giving umami. Due to the hydrolysis at the conditions of high temperature and acidity, substances giving HVP-specific flavors and taste are generated via chemical reactions from sugars, amino acids, organic acids and lipids. It has been known that sotolone as a flavor component and formic acid and levulinic acid as tasteful components are generated.

Meanwhile, the following traditional process produces soy sauce. First, the raw material defatted soybean is steamed and then mixed with which an almost equal volume of frizzled and split wheat. Spores of koji mold are then inoculated in the resulting mixture for koji production. The resulting koji is mixed with an aqueous salt solution to prepare unrefined soy, which is then fermented and aged for a long period of time to prepare soy sauce. The taste is ascribed to the amino acids and peptides therein. Since only about 50% of the proteins is hydrolyzed, the resulting soy sauce contains a lower content of amino acids, particularly glutamic acid, compared with HVP. Thus, the resulting soy sauce has a poor taste titer. Further, the resulting soy sauce has unique soy sauce flavor due to the various alcohols, esters and organic acids (e.g., acetic acid) generated by yeast and lactic acid in the soy sauce during the aging time of a half-year or more.

As described above, HVP and soy sauce have been used domestically and overseas as fundamental seasoning materials. HVP and soy sauce serve to enhance taste such as umami and body as well as to impart unique flavor to various processed food products and seasonings. Because HVP and soy sauce are commonly in a liquid form at a salt content at 10 to 20%, the salty taste is too strong when a large volume of HVP or soy sauce is used. Consequently, a problem occurs such as no emergence of umami and body at desirable intensities. Because salt contained in some processed foods affects the physico-chemical properties of the processed food products and the taste thereof, the amount of HVP or soy sauce for use therein is limited. As such, a disadvantage arises such as an inability to obtain the umami or body at a desirable intensity. For example, the formation of set gel of fish cakes such as boiled fish paste in roll-cake shape (i.e., “kamaboko” in Japanese) is suppressed when a large amount of salt is added thereto. Therefore, a large amount of HVP or soy sauce cannot be added. Accordingly, preferably, a fundamental seasoning material at a low content of salt is preferable as such fundamental seasoning material for giving umami and body.

If HVP or soy sauce can be produced that does not contain a large amount of salt but still has umami and body, the concentration of salt can be adjusted, appropriately, so that not only the frequency of the use of such HVP or soy sauce by food manufacturers can be increased to unprecedented levels, but also umami and body can be given to a wide variety of processed food products and seasonings. Because unnecessary salt addition is avoided, the consumer intake of salt can be reduced. Soy sauce at a low salt content (salt-reduced soy sauce) is available, which is produced by desalting the soy sauce produced by authentic brewery. However, the umami and body of salt-reduced soy sauce, as well as salt contained in soy sauce, is disadvantageously reduced. Thus, even such soy sauce cannot meet the object described above.

Because both HVP and soy sauce have a strong and unique flavor, in addition to the problem of HVP and soy sauce due to the salt therein (supra), HVP and soy sauce when used at a large amount in foods and seasonings disadvantageously damage the flavor balance in the resulting processed food products and seasonings. Further, HVP and soy sauce mask the flavor of other food materials and seasoning materials. In particular, complex food flavor desired by consumers is lost, so that the resulting processed food products and seasonings have a monotonous flavor. For example, only the flavor of soy sauce being enhanced. Noodle soup is one of such examples. Noodle soup is prepared by mixing together the broth prepared mainly from dried bonito and soy sauce. But aroma components of soy sauce, for example isobutyl alcohol (iba), n-butyl alcohol (nba) and isoamyl alcohol (iaa) mask the flavor of the soup from dried bonito, so that the overall flavor is deteriorated, disadvantageously (Japanese Patent No. 2862719).

Thus, a fundamental seasoning material with flavor not too strong is desirable to serve as the fundamental seasoning material giving taste comprising umami and body. If such a seasoning with less flavor is obtained, HVP and soy sauce can be partially mixed and used, when HVP flavor and soy sauce flavor are needed. Additionally, an appropriate amount of flavor not masking the flavor of other food materials and seasoning materials can be given, appropriately.

As soy sauce with less flavor, so far, deodorized soy sauce with less aroma components of soy sauce such as iba, nba and iaa has been developed, which is prepared by purging nitrogen gas into soy sauce (Japanese Patent No. 2862719). Also a type of soy sauce has also been developed, which is prepared by hydrolyzing solid koji in the absence of salt at high temperature for a short period of time (Japanese Patent Application 2002-103013).

As described above, the fundamental seasoning material giving taste such as umami and body is desirably a fundamental seasoning material with no salt content and without a strong flavor component. From the standpoint of taste titer, desirably, amino acids in a raw protein material are in the free forms at a ratio larger than that in soy sauce, and if possible, at almost 100% as in HVP. The high HVP hydrolysis ratio to amino acids is owing to the production process, namely acid hydrolysis. However, 3-MCPD generated in the course of the acid hydrolysis has increasingly been regulated. In Europe, for example, there is a provision of the upper limit in the statute. Regulations over 3-MCPD are increasingly stricter. Desirably, not the acid hydrolysis process but the same traditional solid koji process as for soy sauce should be selected for a process of producing fundamental seasoning materials, which may be developed in future.

Those described above can be summarized as follows. As the fundamental seasoning material giving umami and body, a fundamental seasoning material giving umami and body as produced by the traditional solid koji process is desired. Specifically, it is desired that the seasoning does not contain salt but is at a content of amino acids per nitrogen as high as that of HVP and does not contain strong flavor components.

As a method for raising the content of amino acids in the production of soy sauce by the solid koji process, a process of koji hydrolysis without salt at a temperature of 2 to 25° C. has been developed (U.S. Pat. No. 5,523,100). In this process, the content of amino acids is surely raised. But the process comprises a step of adding salt to fermented koji after the hydrolysis to ferment the resulting unrefined soy. Therefore, the resulting soy sauce disadvantageously contains salt. Additionally, a process comprising a step of hydrolyzing a mixture of koji and yeast in the absence of salt at 2 to 25° C. is also disclosed (U.S. Pat. No. 5,888,561). Because yeast is used in the process, however, the resulting soy sauce essentially contains flavor components.

Further, technical information is disclosed for producing soy sauce and seasonings by using a koji species with endopeptidase and exonuclease activities, which are 2-fold or greater than that of the wild Aspergillus oryzae strain (U.S. Pat. No. 6,090,607). However, disadvantageously, the resulting products contain salt.

A process is disclosed for preparing fermented protein koji from protein-containing materials and carbohydrates and hydrolyzing the fermented protein koji at a temperature of 15° C. to 60° C. and pH 4.5 to 10 for 6 hours to 28 days, where a lactic acid bacterium of 10³ to 10⁷ cfu per gram of fermented protein koji is inoculated at either the fermented protein koji stage or the hydrolysis stage (U.S. Pat. No. 5,965,178). Because the hydrolysis in the absence of salt at low temperature involves a risk of the growth of undesirable microorganisms, the culture of a lactic acid bacterium is inoculated as described above to thereby protect koji from the growth of the undesirable microorganisms. At that amount of the inoculated microorganisms the growth of lactic acid bacteria occurs during koji production and hydrolysis. Therefore, amino acids released during the hydrolysis are particularly assimilated so that the recovery of amino acids is reduced.

Herein, a process of producing koji by using raw materials after lactic acid fermentation is known for producing fermented seasoning (Japanese Patent No. 3027352). According to the process, however, koji is mixed with aqueous salt solutions.

### SUMMARY OF THE INVENTION

Accordingly, it is an object of the present invention to provide a seasoning obtained by hydrolyzing vegetable protein by the same solid koji process as for soy sauce. In this object is that the salt content of the resultant product is either zero or is a low salt content. Further in this object, it is desired that there be a high hydrolysis ratio to amino acids and scarcely contains strong flavor components.

In another object of the present invention is a process for producing a hydrolyzed vegetable protein as described above.

In accordance with the invention, a seasoning can be produced, which is at the zero content of salt or at a low content of salt and which is at a high hydrolysis ratio to amino acids, and in which isobutyl alcohol, n-butyl alcohol, isoamyl alcohol and acetic acid are reduced.

The above objects highlight certain aspects of the invention. Additional objects, aspects and embodiments of the invention are found in the following detailed description of the invention.

### DETAILED DESCRIPTION OF THE INVENTION

Unless specifically defined, all technical and scientific terms used herein have the same meaning as commonly understood by a skilled artisan in fermentation and food chemistry.

All methods and materials similar or equivalent to those described herein can be used in the practice or testing of the present invention, with suitable methods and materials being described herein. All publications, patent applications, patents, and other references mentioned herein are incorporated by reference in their entirety. In case of conflict, the present specification, including definitions, will control. Further, the materials, methods, and examples are illustrative only and are not intended to be limiting, unless otherwise specified.

The present invention is based in part on the Inventors' surprising discovery that a seasoning can be produced, which is at the zero content of salt or at a low content of salt and which is at a high hydrolysis ratio to amino acids, and in which isobutyl alcohol, n-butyl alcohol, isoamyl alcohol and acetic acid are reduced.

So as to overcome the problems known to exist in the art, the inventors have made investigations. Consequently, the inventors have found that acetic acid in addition to aroma components comprising isobutyl alcohol, n-butyl alcohol and isoamyl alcohol contained in soy sauce masks the taste and flavor of other seasonings and food materials and that an excellent seasoning can be obtainable by reducing the contents thereof. Then, the inventors have successfully obtained a seasoning with reduced amounts of the aroma components with no addition of salt, by allowing an appropriate amount of a lactic acid bacterium to exist at both the koji production step and the koji hydrolysis step (fermentation) in the production of soy sauce.

Specifically, the invention is as follows.

A seasoning produced by interacting one or more microorganisms having protein hydrolysis potency with raw materials containing vegetable protein, wherein the hydrolysis ratio to amino acids is 65% or more; the isobutyl alcohol concentration is 0.1 mg per gram of nitrogen or less; the n-butyl alcohol concentration is 0.25 mg per gram of nitrogen or less; the isoamyl alcohol concentration is 0.5 mg per gram of nitrogen or less; and the acetic acid concentration is 100 mg per gram of nitrogen or less.

In one embodiment, the seasoning has a raw material containing vegetable protein which is defatted soybean.

In another embodiment, the microorganisms used for protein hydrolysis are filamentous fungi, which belong to the genus Aspergillus. In a preferred embodiment, at least one of the microorganisms are Aspergillus oryzae and/or Aspergillus sojae.

In another embodiment of the present invention is a process of producing a seasoning by

(i) preparing solid koji by inoculating microorganisms with protein hydrolysis potency in raw materials containing vegetable protein; and

(ii) hydrolyzing the protein by adding a solution to the resulting solid koji at an amount approximating to a salt concentration not inhibiting the hydrolysis of the protein to form unrefined soy and fermenting the unrefined soy,

wherein lactic acid bacteria are added at 10⁸ to 10¹¹ cells per gram of raw material to the raw materials at the step (i) and at the step (ii), if necessary, lactic acid bacteria are added at 10⁸ to 10¹¹ cells per gram of unrefined soy to the unrefined soy and the seasoning is at a hydrolysis ratio to amino acids at 65% or more; an isobutyl alcohol concentration at 0.1 mg per gram of nitrogen or less; an n-butyl alcohol concentration at 0.25 mg per gram of nitrogen or less; an isoamyl alcohol concentration at 0.5 mg per gram of nitrogen or less; and an acetic acid concentration at 100 mg per gram of nitrogen or less.

In an embodiment of the present invention, the salt concentration in the unrefined soy at the step (ii) is 5% by weight or less.

In another embodiment of the present invention, the raw material containing vegetable protein is defatted soybean.

In yet another embodiment of the present invention, the defatted soybean is modified and swelled in extruder to a nitrogen solution index (NSI) of 8 to 20.

In another embodiment of the present invention, the step (ii) is carried out at 5 to 45° C. for 40 to 144 hours.

In still a further embodiment of the present invention, the unrefined soy at the step (ii) is pH 4 to 10.

In yet another embodiment of the present invention, where the nitrogen of a volume 2- to 10 fold the volume of the headspace of the fermentation tank is purged to the headspace above the unrefined soy and then the tank is sealed at the step (ii).

In the process of the present invention, the volume of nitrogen for substitution may be 5- to 8 fold the volume of the headspace of the tank.

Further in the process of the present invention, the microorganisms with protein hydrolysis potency are filamentous fungi, which belong to the genus Aspergillus. In a preferred embodiment, at least one of the microorganisms are Aspergillus oryzae and/or Aspergillus sojae.

In another embodiment, the lactic acid bacterium is Lactococcus lactis.

### BEST MODE FOR CARRYING OUT THE INVENTION

The invention is now described in detail hereinbelow.

As used herein and well known in the art, the term “umami” represents a fifth taste, umami, which is gaining recognition among Western cultures. It is boullion-like savory taste that is conveyed by several substances such as sodium salts of L-glutamate or 5′-ribonucleotides and their mixtures.

The seasoning of the invention is a seasoning obtained by allowing one or more microorganisms with protein hydrolysis potency to interact with raw materials containing vegetable protein, where the hydrolysis ratio to amino acids is 65% or more; the isobutyl alcohol concentration is 0.1 mg per gram of nitrogen or less; the n-butyl alcohol concentration is 0.25 mg per gram of nitrogen or less; the isoamyl alcohol concentration is 0.5 mg per gram of nitrogen or less; and the acetic acid concentration is 100 mg per gram of nitrogen or less.

The hydrolysis ratio to amino acids is preferably 80% or more, more preferably 85% or more. The isobutyl alcohol concentration is preferably 0.08 mg per gram of nitrogen or less, more preferably 0.06 mg per gram of nitrogen or less. The n-butyl alcohol concentration is preferably 0.1 mg per gram of nitrogen or less, more preferably 0.05 mg per gram of nitrogen or less. The isoamyl alcohol concentration is preferably 0.4 mg per gram of nitrogen or less, more preferably 0.3 mg per gram of nitrogen or less. The acetic acid concentration is preferably 60 mg per gram of nitrogen or less, more preferably 30 mg per gram of nitrogen or less.

The amount of nitrogen can be analyzed for example by the Kjeldahl method. Additionally, the amount of amino acid, the amount of acetic acid, and the amount of aroma components can be analyzed by amino acid analyzers, organic acid analyzers and gas chromatography, respectively.

In accordance with the present invention, the term “hydrolysis ratio to amino acids” means the ratio of free amino acids to the total amount of amino acids contained in the hydrolyzed solution.

The raw materials containing vegetable protein comprise any raw material containing vegetable protein appropriate for foods, which can be hydrolyzed efficiently to amino acids with microorganisms with protein hydrolyzing potency. The raw materials comprise for example cereals and beans. Specifically, the raw materials comprise soybean, particularly defatted soybean. In accordance with the invention, the raw materials are composed of one kind or a mixture of two kinds or more. The raw material is particularly preferably defatted soybean. The defatted soybean may be mixed with an appropriate amount of wheat flour and the like.

The microorganisms with protein hydrolysis potency are preferably microorganisms, which can hydrolyze vegetable protein to a 65% or more hydrolysis ratio to amino acids and are appropriate for food production and which can additionally extracellularly secrete protein hydrolyzing enzymes such as protease and peptidase. Such microorganisms comprise for example microorganisms of genera Aspergillus, Rhizopus, Mucor and Monascus. Among them, the genus Aspergillus is preferable. Specifically, for example, A. oryzae, A. sojae, A. awamori, A. nidulans and A. niger are preferable. Among these microorganisms, A. oryzae and A. sojae are particularly preferable.

Because the seasoning of the invention as described above is at a 65% or more hydrolysis ratio to amino acids, the seasoning has a larger taste titer of amino acids than that of soy sauce. Additionally, the concentrations of isobutyl alcohol, n-butyl alcohol and isoamyl alcohol as the aroma components of soy sauce are lower than those in soy sauce of the related art. Due to the lower concentration of acetic acid therein, still additionally, the seasoning of the invention does not mask the taste and flavor of other seasonings and food materials but gives umami and body, compared with soy sauce of the related art and the deodorized soy sauce with aroma components reduced by nitrogen gas purging (Japanese Patent No. 2862719). Because the seasoning is at the zero content of salt or at a low content thereof, additionally, the seasoning is preferably used for foods in which the amount of salt used should be limited. If necessary, an appropriate amount of salt is added to the seasoning of the invention or a food using the same, to adjust the salt concentration to a desired concentration.

The process of producing the seasoning of the invention is now described below. The following steps can produce the seasoning of the present invention.

(i) A step of preparing koji by inoculating microorganisms with protein hydrolysis potency in raw materials containing vegetable protein (Koji preparation step).

(ii) A step of hydrolyzing the protein, by adding a solution to the resulting koji at an amount approximating to a salt concentration not inhibiting the hydrolysis of the protein, to form unrefined soy and then fermenting the unrefined soy to hydrolyze the soybean protein (also referred to as fermentation step).

First, the koji preparation step is now described in more detail.

The raw materials containing vegetable protein comprise any raw material containing vegetable protein appropriate for foods, which can be hydrolyzed efficiently to amino acids with microorganisms with protein hydrolysis potency. The raw materials comprise for example cereals and beans. Specifically, the raw material comprises soybean, particularly defatted soybean. In accordance with the invention, the raw materials are composed of one kind or a mixture of two kinds or more. The raw material is particularly preferably defatted soybean, but the defatted soybean may be mixed with an appropriate amount of wheat flour.

Further, the defatted soybean is preferably modified and swelled by heating and is subsequently dried to a dry puffed bean. In such manner, the microorganisms with protein hydrolysis potency can readily permeate into the inside of puffed soybean, while the water content of the raw materials can be readily adjusted to 35 to 45%, which is suitable for the growth of koji mold. Further, a large amount of the lactic acid bacterium can be inoculated. The modification and swelling under heating is preferably carried out to a nitrogen solution index (NSC) of 8 to 20.

The microorganisms with protein hydrolysis potency are inoculated in such raw materials as described above, to prepare koji. In accordance with the invention, any of solid koji and liquid koji may be applicable. Solid koji induces more kinds and larger amounts of protein hydrolyzing enzymes generated by the microorganisms such as protease and peptidase, which indicates that solid koji involves a higher hydrolysis ratio of amino acids. Thus, solid koji is preferable.

In accordance with the invention, the lactic acid bacterium is added to the raw material at a concentration of 10⁸ to 10¹¹ cells per gram of raw material, at least at the koji preparation step of the koji preparation step and the fermentation step. As described below, in accordance with the present invention, the hydrolysis of solid koji is done at a salt amount approximating to a salt concentration not inhibiting the hydrolysis with koji molds, for example at a salt concentration of 5% by weight or less. The term “at a salt amount approximating to a salt concentration not inhibiting the hydrolysis” means the amount corresponding to a salt concentration substantially not inhibiting the hydrolysis or a salt concentration low enough to cause the inhibition of the hydrolysis when it eventually happens to give no damage to the advantages of the invention. Specifically, the hydrolysis is not inhibited at a hydrolysis ratio to amino acids at 65% or more, preferably 80% or more, and more preferably 85% or more.

In the koji for soy sauce in the related art, microorganisms of 10⁶ to 10¹⁰ cells per gram of koji are viable at the stage of dekoji (meaning one of koji preparation steps, where koji is finally prepared for completion). When such koji is mixed with a solution at a low salt concentration, the resulting mixture decays in several hours. Particularly when only defatted soybean is used as the raw material, the water content after steaming increases as high as 50 to 60%. In that case, therefore, contaminations with microorganisms such as Bacillus natto occur more readily than in soy sauce koji prepared by mixing an equal amount of dry wheat flour. In accordance with the invention, thus, the lactic acid bacterium is inoculated in the raw material and koji, to suppress the growth of undesirable microorganisms and prevent koji from abnormal fermentation and decay due to the growth of undesirable microorganisms.

In accordance with the invention, the koji preparation can be done in the same manner as for koji preparation in the general production of soy sauce, except for the inoculation of the lactic acid bacterium. Specifically, a raw protein material is mixed with water, the lactic acid bacterium and seed koji. Water is preferably added to 35 to 45% by weight, preferably 37 to 42% by weight of the total weight of the mixture. The lactic acid bacterium is inoculated to 10⁸ to 10¹¹ cells/g per gram of raw material s, preferably 10⁹ to 10¹⁰ cells per gram of raw materials. By inoculating the lactic acid bacterium within the range at an early stage of the koji preparation, in particular, the colonies can be retained dominantly in the koji, to eliminate the possibility of the growth of other undesirable microorganisms.

Any lactic acid bacterium substantially not inhibiting the activity of microorganisms with protein hydrolysis potency, to suppress the growth of undesirable contaminating microorganisms is satisfactory with no specific limitation. Such lactic acid bacterium comprises for example bacteria of genera Lactobacillus and Lactococcus. Among the two, the genus Lactococcus is preferable. More specifically, L. lactis is preferred.

Water and the lactic acid bacterium can be mixed with the raw material in the form of a liquid culture of the lactic acid bacterium. Specifically, a liquid culture of lactic acid bacterium is sprinkled for example on the modified and swelled raw material while heating. The liquid culture of the lactic acid bacterium preferably contains 10⁸ to 10¹¹ bacterial cells/mL or if possible, 10⁹ to 10¹⁰ bacterial cells/mL. The number of the bacterial cells of the lactic acid bacterium can be counted with a microscope. Otherwise, colony-forming units on an agar culture medium suitable for the growth are counted, to assay the number.

Additionally, spores of koji mold are added to a spore number of 10⁶ to 10⁷ spores per gram of raw materials. The spore number of seed koji can be counted in the same manner as for the bacterial cell number of the lactic acid bacterium.

The koji preparation step is performed by incubating the mixture of raw materials and koji mold, generally at 22 to 40° C., preferably 28 to 35° C. for 24 to 72 hours, preferably 38 to 60 hours. 18 to 28 hours after the start of the koji preparation, manual mixing (“te-ire” in Japanese) may satisfactorily be done.

The fermentation step of the present invention is now described.

The resulting koji is added to the koji prepared as described above to form unrefined soy, which is then fermented to hydrolyze soybean protein. In accordance with the invention, generally, no salt is added to the solution or the unrefined soy. The salt concentration is preferably 5% by weight or less, more preferably 2% by weight or less of the total weight of the unrefined soy. Further, the unrefined soy may contain a small amount of salt derived from the liquid culture of the lactic acid bacterium.

At the fermentation step, the addition of the lactic acid bacterium to the unrefined soy is not essential, but is preferable. When the lactic acid bacterium is added to the unrefined soy, the lactic acid bacterium is inoculated to 10⁸ to 10¹¹ cells per gram of unrefined soy or, preferably 10⁹ to 10¹⁰ cells per gram of unrefined soy. The increase in the number of the lactic acid bacterium further grows the lactic acid bacterium from an early stage of the fermentation step, to thereby suppress the assimilation of the amino acids generated by the hydrolysis.

The solution is preferably added, generally at a 1.5- to 5-fold, preferably 2- to 4-fold the weight of koji. The solution and the lactic acid bacterium can be mixed in the form of a liquid culture of the lactic acid bacterium with the raw material. In such case, the liquid culture of the lactic acid bacterium preferably contains the bacterial cells of 10⁹ to 10¹⁰ cells/mL.

The fermentation step is carried out at a temperature where the lactic acid bacterium can grow, in general 5 to 45° C., preferably 30 to 37° C., for 40 to 144 hours, preferably for 48 to 96 hours. Additionally, the pH of the unrefined soy is adjusted to preferably 4 to 10, more preferably 5 to 7.

At the fermentation step, additionally, nitrogen is preferably purged to the headspace above the unrefined soy. Thereby, the proliferation of undesirable aerobic microorganisms can be suppressed. As to the degree of nitrogen substitution, for example, nitrogen gas of a volume 2- to 10 fold, preferably 5- to 8 fold the headspace volume of a tank with the unrefined soy is used. Then, the tank is sealed.

The fermentation step is carried out as described above, to thereby prevent the growth or proliferation of undesirable microorganisms. Because yeast involved in the general soy sauce production hardly grows, additionally, the soy sauce flavor is possibly reduced.

After the completion of the fermentation step, the same general procedures as for soy sauce can be performed. For example, the unrefined soy is filtered to discard solids therein, and then sterilized at 60 to 120° C. Otherwise, the unrefined soy may be sterilized and then filtered, satisfactorily. The resulting unrefined soy is used as a raw material for other fermentation seasonings or fermentation food products.

Having generally described this invention, a further understanding can be obtained by reference to certain specific examples, which are provided herein for purposes of illustration only, and are not intended to be limiting unless otherwise specified.

### EXAMPLES

In the following examples, herein, “TN” means nitrogen and “gTN” means gram of nitrogen.

### Example 1

A liquid culture containing 10⁹ to 10¹⁰ cells/mL of lactic acid bacterium (L. lactis NBRC 12007) was preliminarily adjusted to pH 6.3. 180 mL of the resulting liquid culture was mixed with 360 g of swelled defatted soybean (manufactured by Ajinomoto Corporation; Protein TY, NSI 15), followed by further mixing spores of koji molds (A. oryzae JCM 2231) with the raw material to 2×10⁶ cells per gram of raw material. Then, the resulting mixture was prepared as koji at 30 to 32° C. for 48 hours according to the general method. 18 and 25 hours later just when the temperature of koji exceeded 32° C., the koji was mixed together. The water content in the mixture was 37%.

Herein, the strain NBRC 12007 was deposited as IFO 12007 at IFO (the Institute for Fermentation, Osaka, Japan). The IFO's duty to store microorganisms has been handed over the National Institute of Technology and Evaluation, Biological Resource Center (NBRC) (2-5-8, Kazusa-Kamatari, Kisarazu-shi, Chiba-ken, 292-0818 (zip code)), where the strain is now stored as strain NBRC 12007. In other words, the strain NBRC 12007 is the same strain as the strain IFO 12007. Additionally, the strain JCM 2231 is stored at Riken, Japan Collection of Microorganisms (JCM) (2-1, Hirosawa, Wako-shi, Saitama-ken, 351-0198 (zip code)). Any of the strains can be supplied by NBRC or JCM.

500 g of the resulting koji was added to 2 L of a liquid culture of a lactic acid bacterium (L. lactis NBRC-12007 (IFO 12007 under old name)), which contained 10⁹ to 10¹⁰ cells/mL of bacterial cells and was preliminarily adjusted to pH 6.3. The resulting mixture was then placed in a pressure-resistant bottle, of which the inside could be sealed from atmosphere through a pinch cock. After nitrogen gas of a volume 5-fold the volume of the headspace in the container was purged into the headspace under atmospheric pressure, the pinch cock was closed to seal the container. The container was incubated at 35° C. for 24 hours, 48 hours, 96 hours, 144 hours and 240 hours, for hydrolyzing the defatted soybean protein with koji.

By discarding solids of unrefined soy, a hydrolyzed solution was prepared and sterilized at 80° C. for 30 minutes. The sterilized solution was incubated overnight at 4° C., from which solids were filtered off and discarded. To the resulting clear liquid of 2 L 20 g of active charcoal (Active Charcoal BA: manufactured by Ajinomoto-Fine-Techno, Co., Inc.) was added and the mixture was incubated at 50° C. for 30 minutes under constant agitation, to deodorize and decolor. Finally, the resulting solution was filtered to remove the active charcoal, to recover a liquid seasoning as the final product.

For the liquid seasoning obtained by the aforementioned procedure, the following tests were done: nitrogen (TN) analysis by the Kjeldahl method, analysis of amino acids (total amino acids) by an amino acid analyzer (Hitachi L-8000), analysis of various organic acid concentrations by an organic acid analyzer (Hitachi L-7000), analysis of various sugar concentrations by a sugar analyzer (Hitachi L-6000), analysis of the aroma components by gas chromatography, pH measurement and an organoleptic test in a homogeneous system by ten sensory evaluation panelists.

A sensory evaluation in a homogeneous system was conducted by a method comprising diluting each sample to a nitrogen concentration (TN) of 0.1% and a salt concentration of 1.0% and supplementing the resulting diluted samples with salts, for sensory evaluation at a state of ambient temperature.

The results of the component analysis of sample products in the individual hydrolysis periods and the sensory evaluation results in a homogeneous system are compared with the results of a commercially available general soy sauce (koikuchi soy sauce). The results are shown in Table 1.

TABLE 1

| | Hydrolysis time | | | | | |
|---|---|---|---|---|---|---|
| | | | | | | General soy |
| | 24 hours | 48 hours | 96 hours | 144 hours | 240 hours | sauce |
| Hydrolysis | 61 | 81 | 83 | 84 | 84 | 52 |
| ratio to | | | | | | |
| amino acids | | | | | | |
| (%) | | | | | | |
| iba | | 0.05 | 0.06 | 0.04 | | 0.33 |
| (mg/gTN) | | | | | | |
| nba | | 0.02 | 0.01 | 0.01 | | 0.66 |
| (mg/gTN) | | | | | | |
| iaa | | 0.28 | 0.32 | 0.45 | | 1.28 |
| (mg/gTN) | | | | | | |
| Acetic acid | 20 | 20 | 70 | 80 | 73 | 143 |
| (mg/gTN) | | | | | | |
| Sensory | weak | umami, | umami, | taste with | refreshing | umami and |
| evaluation | umami, | strong first | strong first | good | taste with | unique soy |
| | small taste | taste, | taste, | umami, | less | sauce flavor |
| | titer | thickness, | thickness | strong first | thickness, | |
| | | final taste | | taste and | weak | |
| | | sustainable | | great | umami | |
| | | | | thickness, | | |
| | | | | but more or | | |
| | | | | less poorer | | |
| | | | | taste | | |
| | | | | compared | | |
| | | | | with the | | |
| | | | | taste in case | | |
| | | | | of 96-hour | | |
| | | | | hydrolysis | | |

Consequently, the hydrolysis ratio of amino acids reached 80% or more by hydrolysis for 48 hours or more. It was found that the resulting soy sauce almost scarcely contained aroma components unique to soy sauce, such as isobutyl alcohol (iba), n-butyl alcohol (nba), isoamyl alcohol (iaa) and acetic acid. The taste of the seasoning obtained in accordance with the invention characteristically comprises strong umami and strong initial taste, as well as thickness. Thus, the taste thereof was far closer to the characteristics of acid-hydrolyzed amino acid solution, rather than those of the taste of soy sauce. Among them, in particular, it was felt that the seasonings of a hydrolysis time of 48 hours to 144 hours had strong umami, initial taste and thickness. Because a small amount of peptides remains in the seasoning in case of the 48-hour hydrolysis, the seasoning had “after taste sustainable”.

As to the order, further, strong flavor unique to acid-hydrolyzed amino acids or soy sauce was not detected. Slight cereal or bean odor was detected. Almost no difference due to these hydrolysis times was observed. In the following Examples, therefore, the hydrolysis time was set at 48 hours to 144 hours.

### Example 2

In the hydrolysis of solid koji, the relation between the hydrolysis temperature and the production stability or the taste of the resulting liquid seasoning or the like was examined. The hydrolysis was performed at temperatures of 30, 35 and 37° C. The hydrolysis time was 96 hours.

500 g of the solid koji obtained by the process described in Example 1 was added to 2 L of a liquid culture containing 10⁹ to 10¹⁰ cells/mL of a lactic acid bacterium (L. lactis NBRC-12007 (IFO 12007 under old name)) and was preliminarily adjusted to pH 6.3. The resulting mixture was placed in a pressure-resistant bottle, of which the inside could be sealed from atmosphere through a pinch cock. After nitrogen gas of a volume 5-fold the volume of the headspace in the container was purged into the headspace, the pinch cock was closed to seal the container. The container was incubated in an incubator for the hydrolysis at the above temperatures for 96 hours. Subsequently, the process described in Example 1, to obtain liquid seasonings, treated the hydrolyzed products.

The results of the component analysis of the sample products with assigned hydrolysis temperatures, the sensory evaluation results in a homogeneous system and the microbial analysis after completion of the hydrolysis are compared with each other and are shown in Table 2.

TABLE 2

| | 30° C. | 35° C. | 37° C. |
|---|---|---|---|
| Hydrolysis ratio to amino acids (%) | 81 | 83 | 84 |
| iba (mg/gTN) | | 0.06 | |
| nba (mg/gTN) | — | 0.02 | — |
| iaa (mg/gTN) | — | 0.39 | — |
| Acetic acid (mg/gTN) | — | 74 | — |
| Bacteria*) (cells/g • unrefined soy) | <20 | <20 | <20 |
| Yeast (cells/g • unrefined soy) | <20 | <20 | <20 |

*) Bacteria except for the inoculated lactic acid bacterium.
The symbol “—” expresses no assay done.

Consequently, the hydrolysis ratio to amino acids did not so much differ between the hydrolysis temperatures of 30 to 37° C.

Thus, the hydrolysis temperature was set at 30 to 37° C. in the following Examples, in view of both the hydrolysis ratio to amino acids and bacteriostasis.

### Example 3

In the present Example, the need of bacteriostasis during the hydrolysis was examined, while in the Examples 1 and 2, the growth of obligate aerobes comprising Bacillus subtilis was suppressed by substituting the headspace air in the upper top of the tank with nitrogen gas during the hydrolysis, to put the whole hydrolysis system at an anaerobic state.

A liquid culture containing 10⁹ to 10¹⁰ cells/mL of a lactic acid bacterium (L. lactis NBRC-12007 (IFO 12007 under old name)) was preliminarily adjusted to pH 6.3. 180 ml of the resulting liquid culture was mixed with 360 g of the swelled defatted soybean (manufactured by Ajinomoto Corporation; Protein TY, NSI 15), followed by further mixing the spores of koji molds (A. oryzae JCM 2231) to 2×10⁶ cells per gram of raw material. Then, the resulting mixture was used for koji preparation, at 30 to 32° C. for 48 hours according to the general method. The water content in the mixture was 37%. Then, the koji was mixed 18 and 25 hours later in the same manner as in the production method of soy sauce koji in the related art.

500 g of the resulting koji was added to 2 L of a liquid culture containing 10⁹ cells/mL of a lactic acid bacterium (L. lactis NBRC-12007 (IFO 12007 under old name)) and was preliminarily adjusted to pH 6.3. The resulting mixture was placed in a pressure-resistant bottle, of which the inside could be sealed from atmosphere through a pinch cock. Herein, the number of the bacterial cells was adjusted by diluting the liquid culture of the lactic acid bacterium containing the cells of the lactic acid bacterium at 10¹⁰ cells/mL with sterile water. Nitrogen gas was purged in the headspace in the container, to substitute the headspace air with nitrogen gas of a volume 5-fold the volume of the headspace in the container. Then, the pinch cock was closed to seal the container. The hydrolysis was done in an incubator at 35° C. for 48 hours. As a control lot, the hydrolysis was done in an incubator at 35° C. for 96 hours, without the nitrogen gas substitution. Subsequently, the process described in Example 1, to obtain liquid seasonings, treated the hydrolyzed products.

Under the above conditions, it was found that koji covered the surface of unrefined soy unless the headspace air was substituted with nitrogen, so that undesirable microorganisms for example cocci and bacteria of the genus Bacillus grew thereon. Thus, it was found that the headspace air in the tank was preferably substituted with nitrogen.

### Example 4

Then, a different lactic acid bacterial species was used, to prepare a seasoning.

L. lactis FERM BP-08552 was cultured in a culture medium of 0.54% of yeast extract, 3% of glucose and 0.5% of NaCl in ajar fermenter at conditions of no purging and an agitation number at 100 rpm for about 18 hours while retaining pH 5.5 with NaOH, to a bacterial cell concentration of 10⁹ to 10¹⁰ cells/mL. The strain was internationally deposited at the National Institute of Advanced Industrial Science and Technology, International Patent Organism Depositary, Central 6, 1-1-1, Higashi, Tsukuba, Ibaraki, Japan (zip code: 305-8566), under the Budapest Treaty. The strain was given Accession No. FERM BP-08552.

The liquid culture containing 10⁹ to 10¹⁰ cells/mL of the lactic acid bacterium (L. lactis FERM BP-08552) was preliminarily adjusted to pH 6.3. 180 ml of the liquid culture was mixed with 360 g of the swelled defatted soybean (manufactured by Ajinomoto Corporation; Protein TY, NSI 15), followed by further mixing the spores of koji molds (A. oryzae JCM 2231) to 2×10⁶ cells per gram of raw material. Then, the resulting mixture was prepared as koji at 30 to 32° C. for 48 hours according to the general method. The water content in the mixture was 37%. Then, the koji was mixed together 18 and 25 hours later, in the same manner as for the production process of soy sauce koji in the related art.

500 g of the resulting koji was added to 2 L of a liquid culture containing 10⁹ cells/mL of a lactic acid bacterium (the liquid culture of L. lactis FERM BP-08552) and was preliminarily adjusted to pH 6.3. The resulting mixture was then put in a pressure-resistant bottle, of which the inside could be sealed from atmosphere through a pinch cock. Herein, the number of the bacterial cells was adjusted by diluting the liquid culture of the lactic acid bacterium containing the cells of the lactic acid bacterium at 10¹⁰ cells/mL with sterile water. Nitrogen gas of a volume 5-fold the volume of the headspace in the container was purged in the headspace in the container, to substitute the headspace with nitrogen gas. Then, the pinch cock was closed to seal the container. The hydrolysis was done in an incubator at 35° C. for 96 hours. Subsequently, the process described in Example 1, to obtain a liquid seasoning, treated the hydrolyzed products.

The results of the component analysis of the liquid seasoning, the sensory evaluation results in a homogeneous system and the microbial analysis are shown in Table 3.

TABLE 3

| | |
|---|---|
| Hydrolysis ratio to amino acids (%) | 82 |
| iba (mg/gTN) | 0.04 |
| nba (mg/gTN) | 0.02 |
| iaa (mg/gTN) | 0.34 |
| Acetic acid (mg/gTN) | 45 |
| Bacteria*) (cells/g • unrefined soy) | <20 |
| Yeast (cells/g • unrefined soy) | <20 |
| Sensory evaluation | umami, strong first taste, thickness |

*) Bacteria except for the inoculated lactic acid bacterium.

Consequently, the bacteriostasis of the hydrolyzed solution could be retained, even in the case that L. lactis FERM BP-08552 was used as the lactic acid bacterium. Additionally, the results of the sensory evaluation and the analytical values were almost the same as in the results in Example 1. As described above, the seasoning obtainable in accordance with the invention could be produced, even when the different lactic acid bacterium was used.

### Example 5

It was considered that because the liquid seasoning of the invention contained only smaller amounts of isobutyl alcohol (iba), n-butyl alcohol (nba) and isoamyl alcohol (iaa), the liquid seasoning even when mixed with a broth from dried bonito would not mask the flavor of the broth but could produce a very tasteful noodle soup. In the resulting noodle soup, the liquid seasoning of the invention had been substituted for the soy sauce fraction. The sensory evaluation thereof was done.

In a composition mainly containing soy sauce, dried bonito (ara hon bushi, kare bushi), sugar, sweet sake (mirin), salt, Monosodium L-glutamate and lactic acid for noodle soup, the soy sauce fraction was substituted with the following seasonings.

1. The liquid seasoning obtainable in accordance with the invention (the liquid seasoning of Example 1 prepared at 35° C. for 96 hours; the same is true hereinbelow.)

2. Commercially available general soy sauce (koikuchi soy sauce)

3. Deodorized soy sauce (the one prepared according to the method described in Japanese Patent No. 2872619.)

4. A liquid seasoning prepared by adding acetic acid at an amount equal to the amount contained in commercially available general soy sauce (koikuchi soy sauce) to the liquid seasoning of the invention.

Using the individual seasonings, noodle soups were prepared by mixing the individual seasonings at the following ratios. Their sensory evaluation was determined.

The concentrations of iba, nba, iaa and acetic acid contained in the individual noodle soups are shown in Table 4.

Sensory panelists (n=4) evaluated the four types of the noodle soups. Then, the taste and flavor and smoke flavor of the noodle soups were ranked in the decreasing order. Then, the noodle soups were generally ranked by the rank method. In other words, the first grade was assigned 4 points; the second grade, 3 points; the third grade, 2 points; and the fourth grade, 1 point. The total of the points from the four panelists was defined as general score. The results are shown in Table 4.

TABLE 4

| | | | | Acetic acid | |
|---|---|---|---|---|---|
| | iba (ppm) | nba (ppm) | iaa (ppm) | (ppm) | General score |
| 1 | 1.0 | 2.0 | 4.0 | 480 | 16 points |
| 2 | 1.3 | 2.6 | 5.1 | 590 | 5 points |
| 3 | 1.1 | 2.2 | 4.3 | 560 | 11 points |
| 4 | 1.0 | 2.0 | 4.0 | 590 | 8 points |

Consequently, the taste and smoke flavor of the noodle soup using the liquid seasoning of the invention instead of soy sauce were most strongly felt. As the component masking the taste and smoke flavor of noodle soup, additionally, it was found that the influence of acetic acid was larger than those of the iaa, iba and nba disclosed in the Japanese Patent No. 2862719. Thus, it is possibly indicated that the liquid seasoning of the invention has an effect to permit the active utilization of the flavor of raw materials because the liquid seasoning does not contain acetic acid.

Numerous modifications and variations on the present invention are possible in light of the above teachings. It is, therefore, to be understood that within the scope of the accompanying claims, the invention may be practiced otherwise than as specifically described herein.

What we claim is:

1. A seasoning produced by interacting one or more microorganisms having protein hydrolysis potency with raw materials containing vegetable protein, wherein the hydrolysis ratio to amino acids is 65% or more; the isobutyl alcohol concentration is 0.1 mg per gram of nitrogen or less; the n-butyl alcohol concentration is 0.25 mg per gram of nitrogen or less; the isoamyl alcohol concentration is 0.5 mg per gram of nitrogen or less; and the acetic acid concentration is 100 mg per gram of nitrogen or less.

2. The seasoning according to claim 1, wherein the raw material containing vegetable protein is defatted soybean.

3. The seasoning according to claim 1, wherein said one or more microorganisms are filamentous fungi which belong to the genus Aspergillus.

4. The seasoning according to claim 3, wherein at least one of the microorganisms is selected from the group consisting of Aspergillus oryzae and Aspergillus sojae.

5. A process of producing a seasoning comprising:
(i) preparing solid koji by inoculating one or more microorganisms with protein hydrolysis potency in raw materials containing vegetable protein; and
(ii) hydrolyzing the protein by adding a solution to the resulting solid koji at an amount approximating to a salt concentration not inhibiting the hydrolysis of the protein to form unrefined soy and then fermenting the unrefined soy,
wherein a lactic acid bacterium is added at 10⁸ to 10¹¹ cells per gram of raw material to the raw materials at the step (i) and at the step (ii), a lactic acid bacterium is added at 10⁸ to 10¹¹ cells per gram of unrefined soy to the unrefined soy and
wherein the seasoning is at a hydrolysis ratio to amino acids at 65% or more; an isobutyl alcohol concentration at 0.1 mg per gram of nitrogen or less; an n-butyl alcohol concentration at 0.25 mg per gram of nitrogen or less; an isoamyl alcohol concentration at 0.5 mg per gram of nitrogen or less; and an acetic acid concentration at 100 mg per gram of nitrogen or less.

6. The process according to claim 5, wherein the salt concentration in the unrefined soy in (ii) is 5% by weight or less.

7. The process according to claim 5, wherein the raw material containing vegetable protein is defatted soybean.

8. The process according to claim 7, wherein the defatted soybean is modified and swelled in extruder to a nitrogen solution index (NSI) of 8 to 20.

9. The process according to claim 5, wherein (ii) is carried out at 5 to 45° C. for 40 to 144 hours.

10. The process according to claim 5, wherein the unrefined soy in (ii) is at pH 4 to 10.

11. The process according to claim 5, wherein nitrogen of a volume 2- to 10-fold the volume of the headspace of the fermentation tank is purged to the headspace above the unrefined soy and then the tank is sealed in (ii).

12. The process according to claim 11, wherein the volume of nitrogen is 5- to 8-fold the volume of the headspace of the tank.

13. The process according to claim 5, wherein said one or more microorganisms with protein hydrolysis potency are filamentous fungi which belong to the genus Aspergillus.

14. The process according to claim 13, wherein at least one of the microorganisms with protein hydrolysis potency is selected from the group consisting of Aspergillus oryzae and Aspergillus sojae.

15. The process according to claim 5, where the lactic acid bacterium is Lactococcus lactis.

16. The process according to claim 15, wherein said lactic acid bacterium is L. lactis FERM BP-08552
